(19) United States
(12) Patent Application Publication
(10) Pub. No.: US 2008/0224616 A1
(43) Pub. Date: Sep. 18, 2008

(54) Lamp and a Method of Attaching a Burner to a Cap of Lamp

(75) Inventor: Petrus Johannes Antonius Linssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,239

(22) PCT Filed: Jan. 10, 2005
(86) PCT No.: PCT/IB05/50104

§ 371 Date: Jul. 18, 2006

(30) Foreign Application Priority Data
Jan. 22, 2004 (EP) 04100193.4

(51) Int. Cl. H01J 17/16

(52) U.S. Cl. 313/634

(57) ABSTRACT

A lamp comprising a cap (6) and a burner (1) attached to the cap, the burner (1) and the cap (6) being connected through a metal part (3), which part engages the burner (1). The metal part (3) has at least two legs (5), preferably three legs (5), such that a portion of each leg engages a corresponding portion of the cap (6). Said corresponding portion is made of synthetic resin material. Said portion of each leg (5) has been heated in order to melt the synthetic resin material and to deform it so as to correspond to the shape of the leg, whereby a mutual engagement of said portion of the leg (5) and said corresponding portion of the cap (6) is obtained.

The invention relates to a lamp comprising a cap and a burner attached to the cap, wherein the burner and the cap are connected through a metal part, which part engages the burner. Such a lamp, in particular a high-pressure discharge lamp, is suitable, for example, for use in mobile applications, such as for automotive headlights.

In general, the burner of a lamp comprises a bulb of transparent glass enveloping means for generating light. Normally, the cap of the lamp is made of synthetic resin material and is provided with electric guiding means for supplying electric power to the burner of the lamp. These guiding means comprise electrical contacts that can engage corresponding contacts at the lampholder, to which the cap can be connected.

For certain applications, such as automotive headlamps or lamps for projecting images on a screen, it is essential that the light source has an exact predetermined position with respect to the cap. The light source will then have a predictable location after the cap has been fixed in the lampholder. Furthermore, the connection between the burner and the cap must be stiff to avoid a relative movement of the burner with respect to the cap.

The object of the invention is a lamp, and a method of attaching a burner to the cap of a lamp whereby the burner is attached to the cap in an effective and simple manner.

To accomplish that object, said metal part, which engages the burner, has at least two legs, and preferably three legs, such that a portion of each leg engages a corresponding portion of the cap, said corresponding portion being of synthetic resin material of the cap, and said portion of each leg has been heated in order to melt the synthetic resin material and to deform it so as to correspond to the shape of the leg, whereby a mutual engagement of said portion of the leg and said corresponding portion of the cap is obtained. Melting the synthetic resin material means that the material becomes weak enough to be deformed.

Such a connection between said metal part and the cap is effective, because the shape of said portion of each leg and the shape of said corresponding portion of the cap will be complementary after the melting of the synthetic resin material, so that a complete engagement between said two portions is realized. Furthermore, this engagement can be realized while the burner and the cap are kept in the desired positions with respect to each other, which positions will be maintained after the connection between the metal part and the cap has been made.

The metal part may engage the burner of the lamp in several ways, but in one preferred embodiment said metal part comprises an annular portion surrounding a cylindrical portion of the burner, such that said legs extend from said annular portion. Said annular portion may be connected to the burner by means of glue or some other intermediary material, however, preferably the said annular portion includes spring means, so that said portion of the burner is engaged by said annular portion clamping around said portion of the burner.

Preferably, the legs, or at least portions of the legs, mutually diverge in directions away from the burner. A stable support of the burner is created thereby, also if the legs themselves are less stiff, or if only two strip-like legs are present.

In one preferred embodiment, said legs are leaf springs, i.e. the legs have a strip-like shape and are made of resilient metal. So, when the material of the leg is heated, the spring force of the leaf spring can press the relevant portion of the leg into the melted synthetic resin material in order to achieve the required engagement. Furthermore, the force exerted by the leaf spring may press the portion of the leg against the engaging portion of the cap in order to maintain the engagement. A less complex shape or a less intensive engagement can then be sufficient to keep said portions connected.

Preferably, said portion of each leg has a shape comprising one or more edges enclosing an angle with the longitudinal direction of the leg. The main force exerted on the connection between the leg and the cap will be in said longitudinal direction, and said edge, engaging the material of the cap, will resist said force easily.

In one preferred embodiment, said portion of each leg comprises one or more holes, so that the synthetic resin material of the cap can flow into said hole or holes when it is melted, resulting in an effective engagement.

The invention further relates to a method of attaching the burner of a lamp to the cap of the lamp, whereby metal part is fixed to the burner and said metal part is fixed to the cap, which metal part has at least two legs, and whereby—during fixation—the burner and the cap are kept in predetermined positions with respect to each other, such that a portion of each leg abuts against a corresponding portion of the cap, said corresponding portion being of synthetic resin material, so that said portion of each leg is heated in order to melt the synthetic resin material and to deform it so as to correspond to the shape of the leg, to obtain a mutual engagement of said portion of the leg and said corresponding portion of the cap.

In one preferred embodiment, said portions of the legs are heated by HF (high-frequency) heating. The lamp, i.e. the burner and the cap, can thus be surrounded by a coil for generating a high-frequency field in order to heat the relevant portions of the legs very fast to the required temperature. Such a heating operation can take place in a few seconds.

The invention will now be further elucidated by means of a description of an embodiment of a lamp, for which reference is made to the drawing comprising Figures, which are only schematic representations, in which:

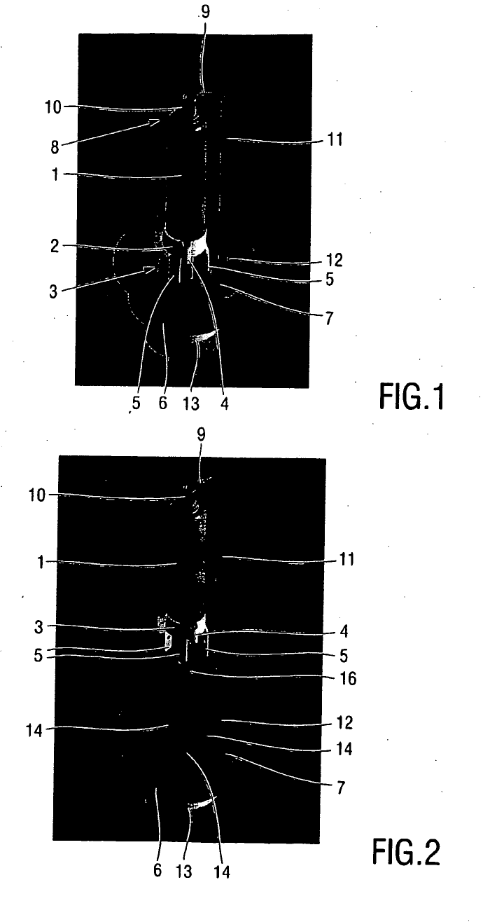

FIG. 1 is a perspective view of the lamp;

FIG. 2 shows the burner at some distance from the cap of the lamp;

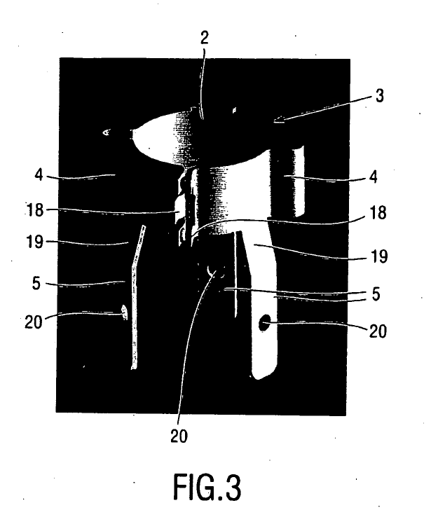

FIG. 3 is a perspective view of the metal part for connecting the cap and the burner; and

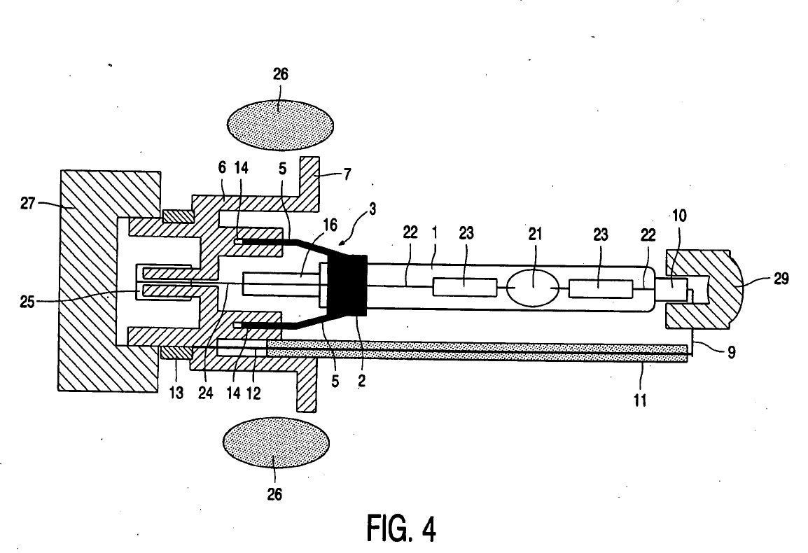

FIG. 4 is a sectional view showing the fixation of the burner to the cap.

FIG. 1 shows a lamp comprising a substantially cylindrical burner 1. The lower part of the burner 1 is surrounded by the substantially annual portion 2 of a metal part 3. The annual portion 2 engages the burner 1 by a clamping action caused by two curved parts 4 of the annual portion 2, which curved parts 4 function as spring means. The metal part 3 also comprises three legs 5 that extend downward in downward direction.

The lamp furthermore comprises a cap 6, substantially made of synthetic resin material. At its upper side, the cap 6 is provided with a flange 7, extending in a radial plane. As is shown in FIG. 1, each of the three legs 5 of the metal part 3 is connected to the cap 6.

The lamp is a high-pressure discharge lamp with a double-ended burner 1, i.e. both ends of the burner are provided with electric guiding means for supplying electric power to the light source in the burner 1. FIG. 1 shows the electric guiding means at the higher end 8 of the burner 1. These guiding means comprise a metal wire 9. A portion of the metal wire 9 is located in a tubular part 10 of the burner 1 and another portion of the wire 9 is located in the tubular member 11, which member 11 extends in axial direction at a distance from the burner 1. Tubular member 11 is fixed in a bore 12 in the cap 6, and wire 9 is connected to an electrical contact 13 at the lower side of cap 6.

FIG. 2 shows the burner 1 and the cap 6 at some distance from the burner 1. The cap 6 is provided with three holes 14 to accommodate the ends of the three legs 5. The shape of the holes 14 corresponds to the shape of the ends of the legs 5, but after the legs 5 have been inserted into the holes 14, there is sufficient clearance between the legs 6 and the holes 14 to allow some movement of the metal part 3 with respect to the cap 6.

Furthermore, cap 6 is provided with a cylindrical bore 12 to accommodate the lower end of tubular member 11. The shape of the bore 12 corresponds to the shape of the lower end of member 11, so that tubular member 11 is kept in its axial position after it has been inserted into the bore 12.

FIG. 2 also shows the tubular part 16 of the burner 1, extending coaxially at the lower end of the burner 1. This tubular part 16 is located between the legs 5 and accommodates the electric guiding means at the lower end of the burner 1.

FIG. 3 shows the metal part 3 in more detail. The metal part 3 has a substantially annular portion 2, which portion may surround a part of the burner 1. After the annual portion 2 has been applied to the burner 1, the annual portion 2 can be closed in that the two radially extending portions 18 are attached to each other. The two portions 18 may be connected by mechanical engagement or by a spot welding operation. The two curved parts 4 act as spring means, so that the burner 1 is firmly engaged by the annular portion 2 of the metal part 3 after the annular portion 2 has been closed.

The metal part 3 also comprises three legs 5 that extend in downward direction. Portions 19 of the legs 5 mutually diverge in the direction away from the burner 1. Near the end of each leg 5 there is a hole 20 in the strip-like material of the leg 5. The ends of the legs 5 may be provided with additional recesses forming edges of the material in a direction inclined to the longitudinal direction. Such edges improve the engagement with the portion of the cap 6 abutting such an edge.

FIG. 4 is a sectional view showing the lamp and means for keeping the burner 1 and the cap 6 of the lamp in the required position while the burner 1 is being fixed to the cap 6.

FIG. 4 shows the burner 1 comprising a space 21 where the light is generated. Electric power is supplied to said space 21 through wires 22 and foils 23, as is usual for a high-pressure discharge burner. The two of the burner 1 are provided with respective tubular parts 10,16 accommodating the metal wires for supplying electric power to the burner 1. Tubular part 11 encloses metal wire 9 on the right-hand side of the burner 1, which wire 9 is further guided through tubular member 11 to the cap 6 of the lamp. In the cap 6, the wire 9 is connected to electrical contact 13 surrounding a portion of the cap 6.

On its left-hand side, the burner 1 is provided with tubular part 16 enclosing metal wire 24. The wire 24 is connected to electrical contact 25 in the central part of the cap 6. The cap is made of synthetic resin material except for the metal contacts 13,25. When the lamp is placed in a lampholder, the lampholder engages the cap 6 of the lamp, and the contacts 13,25 make contact with corresponding electrical contacts in the lampholder.

FIG. 4 also shows the metal part 3 having an annular portion 2 surrounding a portion of the burner 1. FIG. 4 shows a metal part with only two legs 5. The legs 5 are inserted in holes 14 in the synthetic resin material of the cap 6. The legs 5 of the metal part 3 are fixed in the holes 14 of the cap 6 in a high-frequency treatment by means of the HF source 26 located around the cap 6. The HF source 26 heats the legs 5, so that the synthetic resin material of the cap 6 surrounding the leg 6 melts and flows into hole 20 (see FIG. 3) in the material of the leg 5. After cooling down, the leg 5 is firmly fixed in hole 14, so that the burner 1, to which the metal part 3 was already fixed, is connected to the cap 6.

During the fixation operation, the burner 1 and the cap 6 are both maintained in an exact predetermined positions with respect to each other. The cap 6 is for this purpose engaged by a tool 27, and the burner 1 is engaged by a tool 29. Both tools are schematically shown in FIG. 4. During the fixation operation, light can be generated in the burner 1, so that the exact location of the generated light can be detected. As a result the burner 1 can be fixed to the cap 6 in such a way that the light source is located in an exact, predetermined position with respect to the cap 6, and also to a lampholder if the cap 6 is fixed to that lampholder in an exact, predetermined position. Such an exact position may be required to obtain an exact position of the light source with respect to a reflector, as is the case in a headlamp of an automobile.

The embodiment of the lamp as described above is only an example; a great many other embodiments are possible, including embodiments with other types of lamps.

1. A lamp comprising a cap (6) and a burner (1) attached to the cap, wherein the burner (1) and the cap (6) are connected through a metal part (3), which part (3) engages the burner (1), characterized in that the metal part (3) has at least two legs (5), a portion of each leg (5) engaging a corresponding portion of the cap (6), said corresponding portion being of synthetic resin material, which portion of each leg (5) has been heated in order to melt the synthetic resin material and to deform it so as to correspond to the shape of the leg (5), whereby a mutual engagement of said portion of the leg (5) and said corresponding portion of the cap (6) is obtained.

2. A lamp as claimed in claim 1, characterized in that said part (3) has three legs (5).

3. A lamp as claimed in any one of the preceding claims, characterized in that said metal part (3) comprises an annular portion (2) surrounding a portion of the burner (1), while said legs (5) extend from said annular portion (2).

4. A lamp as claimed in claim 3, characterized in that said annular portion (2) includes spring means (4), so that said portion of the burner (1) is engaged by said annular portion (2) by clamping.

5. A lamp as claimed in any one of the preceding claims, characterized in that at least portions of the legs (5) mutually diverge in the direction away from the burner (1).

6. A lamp as claimed in any one of the preceding claims, characterized in that said legs (5) are leaf springs.

7. A lamp as claimed in any one of the preceding claims, characterized in that said portion of each leg (5) has a shape comprising one or more edges that enclose an angle with the longitudinal direction of the leg (5).

8. A lamp as claimed in any one of the preceding claims, characterized in that said portion of each leg (5) comprises one or more holes (20).

9. A method of attaching the burner (1) of a lamp to the cap (6) of the lamp, whereby a metal part (3) is fixed to the burner (1) and said metal part (3) is fixed to the cap (6), characterized in that the metal part (3) has at least two legs (5), and in that—during fixation—the burner (1) and the cap (6) are kept in a predetermined position with respect to each other such that a portion of each leg (5) abuts against a corresponding portion of the cap (6), said corresponding portion being of synthetic resin material, in which method said portion of each leg (5) is heated in order to melt the synthetic resin material and to deform it so as to correspond to the shape of the leg (5), to obtain a mutual engagement of said portion of the leg (5) and said corresponding portion of the cap (6).

10. A method as claimed in claim 8, characterized in that said portions of the legs (5) are heated by HF (high-frequency) heating.
